(19) United States
(12) Patent Application Publication
(10) Pub. No.: US 2008/0128043 A1
(43) Pub. Date: Jun. 5, 2008

(54) INSULATED SUBSEA PIPE WITH FLEXIBLE INSULATION

(76) Inventor: Lou Watkins, Stoughton, MA (US)

Correspondence Address: O'SHEA, GETZ & KOSAKOWSKI, P.C., 1500 MAIN ST., SUITE 912, SPRINGFIELD, MA, 01115, US

(21) Appl. No.: 11/625,501

(22) Filed: Jan. 22, 2007

Related U.S. Application Data
(60) Provisional application No. 60/760,692, filed on Jan. 20, 2006.

(51) Int. Cl. F16L 9/18

(52) U.S. Cl. 138/149; 138/129; 138/145; 138/150

(57) ABSTRACT

An insulated length of pipe includes a length of pipe and a flexible insulating material coating lengthwise surrounding the length of pipe. The flexible insulating coating comprises syntactic foam and a length conformable tape including a relatively narrow elastomeric extrusion spirally wrapped around the length of pipe and embedded within the syntactic foam where the elastomeric extrusion comprises a gelatinous filler. The majority of the insulating coating includes syntactic foam whose flexibility is increased by relatively narrow conformable tape wound spirally (e.g., helically) around the pipe.

### PRIORITY INFORMATION

This application claims priority under 35 U.S.C. §119(e) from U.S. provisional application Ser. No. 60/760,692 filed Jan. 20, 2006, which is hereby incorporated by reference.

### BACKGROUND OF THE INVENTION

The present invention relates to the field of insulation for subsea pipe, and in particular to insulated subsea pipe with flexible insulation.

Syntactic foam is increasingly used as thermal insulation on offshore oil pipelines and subsea equipment. The insulation helps maintain temperature of the well products and prevent coagulation due to cooling. Syntactic foam (e.g., tiny glass microspheres embedded in a plastic resin binder) is an effective insulation because of its light weight and resistance to water absorption. However, achieving a proper balance of physical properties is difficult because the most durable binder materials, such as epoxy, tend to be rigid and are prone to cracking when flexed by bending or thermal expansion. Highly flexible materials such as polyurethane or rubber often break down under the hot, wet conditions at the wellhead. The subject invention aims to increase the flexibility of otherwise rigid materials and make them more useful for subsea insulation.

### SUMMARY OF THE INVENTION

An insulated length of pipe includes a length of pipe and a flexible insulating material coating lengthwise surrounding the length of pipe. The flexible insulating coating comprises syntactic foam and a length of relatively narrow elastomeric extrusion spirally wrapped around the length of pipe and embedded within the syntactic foam where the elastomeric extrusion comprises a gelatinous filler.

An insulated length of pipe includes a length of pipe and an insulating coating. A majority of the insulating coating includes syntactic foam whose flexibility is increased by relatively narrow conformable tape wound spirally (e.g., helically) around the pipe.

The tape is preferably an elastomeric material that is filled with gelatinous material.

Advantageously, the technique of the present invention facilitates use of a durable and long-lasting rigid plastic binder resin, thereby improving the functionality of the insulation system, while increasing flexibility and preventing cracks that would otherwise detract from system efficiency.

These and other objects, features and advantages of the present invention will become more apparent in light of the following detailed description of preferred embodiments thereof, as illustrated in the accompanying drawings.

### BRIEF DESCRIPTION OF THE DRAWING

FIG. 1 is a perspective view of a length of insulated pipe; and

FIG. 2 a partial cross-sectional illustration of a portion of the length of pipe.

### DESCRIPTION OF THE INVENTION

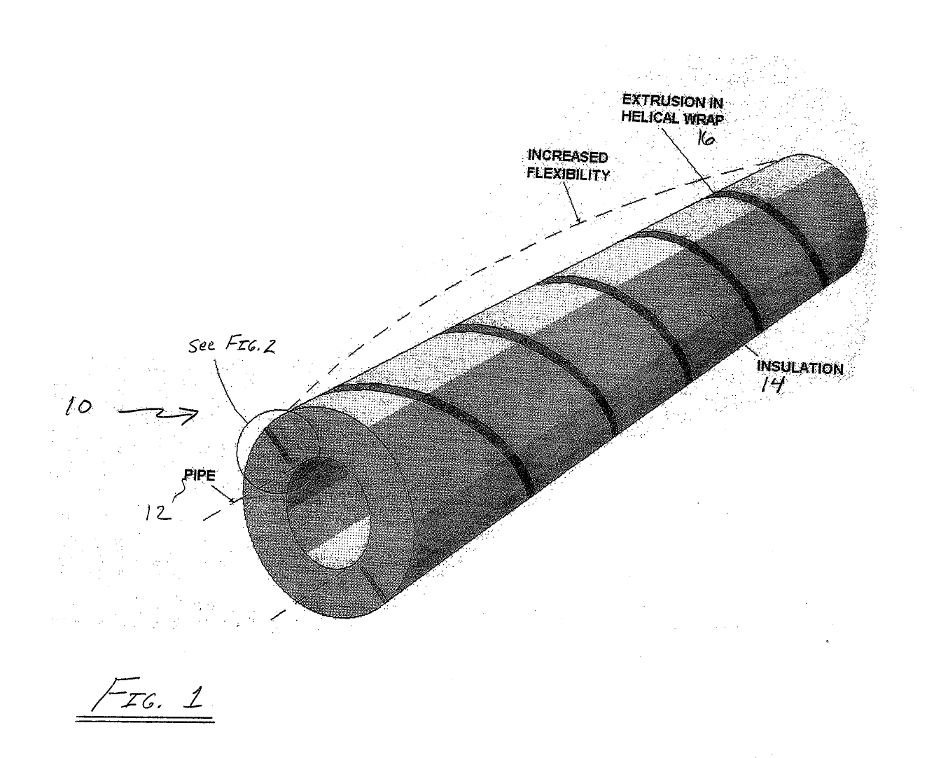

FIG. 1 illustrates a perspective view of an insulated length of pipe 10. The insulated length of pipe includes an inner steel pipe 12 that is encased lengthwise with syntactic foam 14. A hollow extrusion of elastomeric material (e.g., natural or synthetic rubber, silicone, or polyurethane, among others) is filled with a gelatinous paste (e.g., glass microspheres in silicone grease) or other suitable low-modulus filler to create a conformable tape 16. The tape is wrapped for example in a spiral geometry (e.g., helically) around the pipe to be insulated. It is contemplated that wrapping geometries other than helical may be used. The wrap is arranged so that clearance space is provided at the inner (ID) side of the insulation, while the tape is flush against the outer (OD) side. This provides increased conformability at the OD, which is where most of the flexure strain occurs. After infiltration of the syntactic foam, the tape 16 is bonded in place and becomes an integral part of the insulation system. Bending of the pipe causes relative movement of the coils of rigid syntactic foam, with alternative expansion and contraction of the flexible tape. Experiments have shown that an arrangement similar to that illustrated in FIG. 1 results in a twenty-five times (25×) increase in flexibility of rigid cast-on-pipe insulation. Other embodiments of the invention may be used to achieve similar improvements for insulation applied to a variety of subsea equipment.

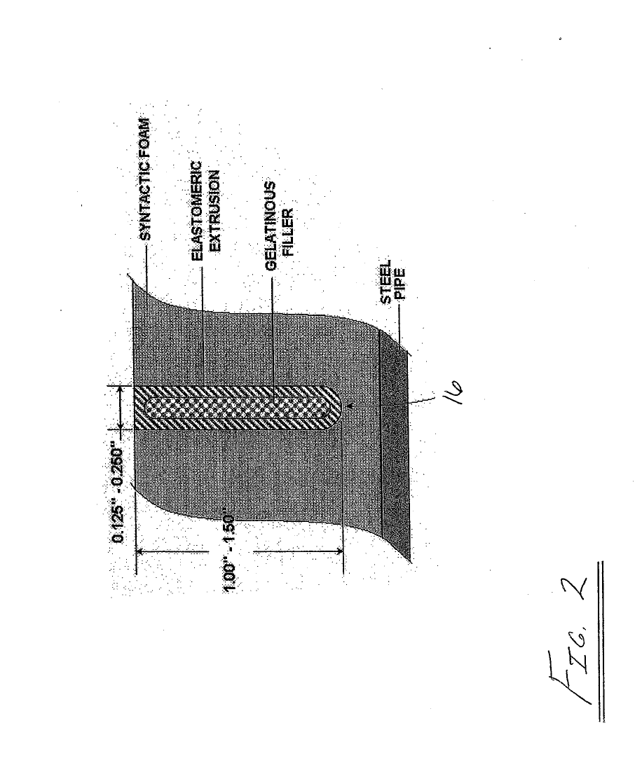

FIG. 2 a partial cross-sectional illustration of a portion of the length of pipe illustrated in FIG. 1.

A technique for manufacturing the insulated pipe according to an aspect of the present invention shall now be explained. First, the steel pipe is cleaned and prepared for coating. Next, a length of plastic tubing, such as extruded polyethylene tubing, is prepared to form the outer jacket, as explained for example in U.S. Pat. No. 6,058,979 assigned to the assignee of the present invention and hereby incorporated by reference. The conformable tape is then affixed to the inner surface of the plastic tubing, arranged in a helical pattern, and positioned with a gap between the tape and the steel pipe. The plastic tubing, with the conformable tape attached, is then drawn over the pipe and sealed at both ends. Next, liquid syntactic foam is injected into the annulus formed between the plastic tubing and the steel pipe, filling all space and embedding the conformable tape. One of ordinary skill in the art will recognize that a number of other manufacturing techniques may be used to provide the insulated subsea pipe with flexible insulation.

Although the present invention has been shown and described with respect to several preferred embodiments thereof, various changes, omissions and additions to the form and detail thereof, may be made therein, without departing from the spirit and scope of the invention.

What is claimed is:

1. An insulated length of pipe, comprising:
a length of pipe;
a flexible insulating material coating lengthwise surrounding the length of pipe, where the flexible insulating coating comprises syntactic foam and a length of relatively narrow elastomeric extrusion spirally wrapped around the length of pipe and embedded within the syntactic foam where the elastomeric extrusion comprises a gelatinous filler.

2. The insulated length of pipe of claim 1, where the elastomeric extrusion comprises rubber.

3. The insulated length of pipe of claim 1, where the elastomeric extrusion comprises silicone.

4. The insulated length of pipe of claim 1, where the elastomeric extrusion comprises polyurethane.

5. The insulated length of pipe of claim 1, where length of relatively narrow elastomeric extrusion spirally wrapped around the length of pipe is flush against an exterior surface of the insulation while the extrusion is spaced from the interior surface of the extrusion.

6. An insulated length of pipe, comprising:
a length of pipe;
a flexible insulating material coating lengthwise surrounding the length of pipe, where the flexible insulating coating comprises syntactic foam and a length of relatively narrow elastomeric extrusion helically wrapped around the length of pipe and embedded within the syntactic foam, where the elastomeric extrusion comprises a gelatinous filler.

7. The insulated length of pipe of claim 6, where length of relatively narrow elastomeric extrusion spirally wrapped around the length of pipe is flush against an exterior surface of the insulation while the extrusion is spaced from the interior surface of the extrusion.

8. The insulated length of pipe of claim 7, where the elastomeric extrusion is about 0.1-0.3 inches wide and has a depth of about 1-2 inches.

9. The insulated length of pipe of claim 8, where the elastomeric extrusion comprises rubber.

10. The insulated length of pipe of claim 8, where the elastomeric extrusion comprises silicone.

11. The insulated length of pipe of claim 8, where the elastomeric extrusion comprises polyurethane.

12. An insulated length of pipe, comprising:
a length of pipe;
a flexible insulating material coating lengthwise surrounding the length of pipe, where the flexible insulating coating comprises syntactic foam and a length of relatively narrow conformable tape spirally wrapped around the length of pipe and embedded within the syntactic foam, where the conformable tape is about 0.12-0.25 inches thick and at least one inch deep and comprises an elastomeric extrusion that encases a gelatinous filler.
